(19) United States
(12) Patent Application Publication
(10) Pub. No.: US 2009/0081334 A1
(43) Pub. Date: Mar. 26, 2009

(54) Process for applying chocolate transfers directly onto rolled fondant

(76) Inventor: Christine M. Schnee, Easley, SC (US)

Correspondence Address: MONAHAN & MOSES, LLC, 13-B W. WASHINGTON ST., GREENVILLE, SC, 29601, US

(21) Appl. No.: 11/903,658

(22) Filed: Sep. 24, 2007

(51) Int. Cl. A23P 1/08; A21C 9/04; A23G 3/54

(52) U.S. Cl. 426/87; 426/383; 99/450.1

(57) ABSTRACT

A method for applying chocolate transfers directly to rolled fondant, and then applying the rolled fondant to a cake, baked good, or other confection is disclosed. The steps of the process include rolling the fondant out to a thickness of about 1/16 of an inch, placing the chocolate transfer directly onto the rolled fondant and covering with a silicone mat and a piece of parchment paper. An iron, such as one used for clothing or crafts, is used as a heat source, and is applied evenly across the parchment paper to heat the chocolate transfer until it adheres to the rolled fondant. Then, after the chocolate transfer/fondant combination is allowed to cool, it may be applied to the cake or confectionary product in a traditional manner. A novel confectionary product, which is at least partially covered by a rolled fondant/chocolate transfer combination is also disclosed, as well as a kit having the necessary tools for utilizing the method described herein.

### 1. FIELD OF THE INVENTION

The present invention relates generally to a method for decorating cakes, baked goods, and other confections. More specifically, the present invention is directed to a method for applying chocolate transfers directly onto rolled fondant, which may then be applied directly to cakes, baked goods, and other confections. The present invention also includes the finished products with chocolate transfers applied to rolled fondant.

### 2. BACKGROUND OF THE INVENTION

Transfer sheets are sturdy but flexible plastic sheets coated with a mixture of cocoa butter and FDA approved food coloring and etched with repetitive designs, such as golden swirls. They come in a wide variety of designs and colors. Some transfer sheets have a single color, such as gold. More complex transfer sheets use up to five different colors in the design. Transfer sheets have traditionally been used with any type of chocolate. The term “chocolate transfer” and the term “transfer” are used interchangeably herein, and include the edible decorative layer that is typically added to the outside of a cake or other confection, by using chocolate as an adhesive agent. The term transfer sheet (or chocolate transfer sheet) is the chocolate transfer, as described above, together with the flexible plastic sheet (plastic transfer sheet) that the transfers are initially attached to.

Traditionally, applying chocolate transfers to cakes has involved a process of laying the chocolate transfer sheet flat on a flat surface, such as a cookie sheet or flat pan, cutting the chocolate transfer sheet to the desired size to cover the top or the sides of a cake, then applying melted chocolate or a melted candy coating smoothly to the chocolate transfer on the opposite side from the plastic transfer sheet (the backside or underside), and then placing the chocolate transfer sheet with the melted chocolate or candy coating onto the appropriate side or section of the cake. The melted chocolate or candy coating serves as the adhesive to secure the chocolate transfer sheet to the cake itself, which is why the decorative edible layer is called a chocolate transfer, even though the layer is not, in fact, chocolate. The cake is then refrigerated or cooled until the chocolate is firm, and then the plastic transfer sheet is peeled away from the outside of the chocolate transfer.

One problem associated with this method is that if the chef waits too long between applying the melted chocolate to the underside of the chocolate transfer sheet and placing the chocolate transfer onto the cake, the melted chocolate hardens and then cracks during application to the cake. Therefore, it would be desirable to provide a process for decorating a cake or other confection with chocolate transfers, but without using a melted chocolate or candy coating to hold the chocolate transfer onto the cake. More specifically, it would be desirable to provide a process for applying chocolate transfers directly to rolled fondant, which could then be applied to a cake, baked good, or other confection. It would also be advantageous to provide a kit with all of the tools necessary for someone to follow the process disclosed and described herein.

### 3. SUMMARY OF THE INVENTION

The present invention is directed to a method for applying chocolate transfers directly to rolled fondant, so that the rolled fondant/chocolate transfer combination may be applied to a cake, baked good, or other confection. The steps of the process include rolling the fondant out to a thickness of about 1/16 of an inch, placing the chocolate transfer directly onto the rolled fondant and covering with a silicone mat and a piece of parchment paper. An iron, such as one used for crafts (having no holes on a bottom surface thereof), is used as a heat source, and is applied evenly across the parchment paper to heat the chocolate transfer until it adheres to the rolled fondant. Then, after the chocolate transfer/fondant combination is allowed to cool, it may be applied to the cake or confectionary product in a traditional manner. The present invention is also directed to the final confectionary product, which is at least partially covered by a rolled fondant/chocolate transfer combination, and further relates to a kit having the necessary tools for utilizing the method described herein.

### OBJECTS OF THE INVENTION

Accordingly, an object of the present invention is to provide a new and improved method for decorating cakes and the like, wherein a chocolate transfer may be applied directly to a rolled fondant, and then the chocolate transfer/fondant combination may be applied to a cake, baked good or other confection.

Another important object of the present invention is to provide a new and improved confectionary item, which is at least partially covered with a rolled fondant having a chocolate transfer embedded therein, without the necessity of using melted chocolate or a melted candy coating to adhere the chocolate transfer to the cake.

Yet another important object of the present invention is to provide a kit for decorating cakes and other confections, wherein the kit includes at least one silicone mat (or other heat transfer material), at least one piece of parchment paper, a heat source, and optionally, at least one chocolate transfer sheet.

Other objects and advantages of the invention will become apparent by consideration of the following description of a specific embodiment thereof.

### DESCRIPTION OF THE DRAWINGS

In the accompanying drawings:

FIG. 1 is an exploded perspective view illustrating a rolled fondant having a chocolate transfer sheet applied to an upper surface thereof, and further including a heat transfer mat above the chocolate transfer sheet, and a sheet of parchment paper above the heat transfer mat; and

FIG. 2 is a perspective view of a cake having a layer of rolled fondant applied thereto, and wherein a layer of chocolate transfer is applied directly to an outer layer of rolled fondant.

### DETAILED DESCRIPTION

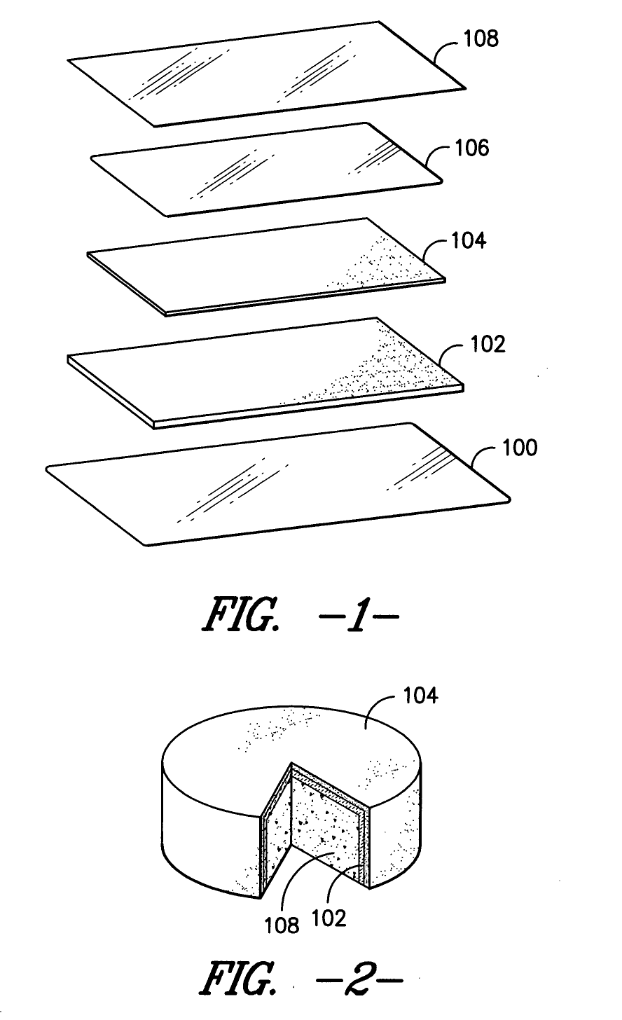

A method for applying chocolate transfers directly onto rolled fondant is disclosed. In the instant method, the first step is to roll out the fondant 102 to a thickness of about 1/16 of an inch, and place the fondant onto a flat surface. In one embodiment of the process, a silicone mat may be placed on the flat surface, and the fondant may be rolled out onto the silicone mat 100. The desired chocolate transfer sheet 104 is then selected and placed directly onto the rolled fondant 102. A silicone mat 106 (or some other heat transfer sheet or mat) is then placed directly over the chocolate transfer sheet, as shown in FIG. 1. The silicone mat 106 is used to evenly distribute heat from a heat source, so that the chocolate transfer 104 and rolled fondant 102 do not melt or overheat. A clear silicone mat 106 is preferred, because it allows a chef to see through the mat to the chocolate transfer during the heating process. Optionally, parchment paper 108 may be placed over the silicone mat, which allows the heat source to glide smoothly over the rolled fondant and chocolate transfer.

The chef then pre-heats a heat source, which in a preferred embodiment is a craft iron with a flat bottom and having no holes, and then glides the heat source over the silicone mat (or optionally over the parchment paper, which sits atop the silicone mat) in a substantially continuous motion, in much the same way one would iron a shirt or other garment, or an iron-on design that is applied to clothing. During this process of ironing the chocolate transfer 104 onto the fondant 102, a fondant smoother, which is essentially a tool having a flat bottom and a handle for smoothing fondant, may be gently rubbed over the transfer, particularly while the transfer is cooling, to assist in the process of adhering and securing the transfer to the fondant, if necessary. After the transfer 104 is adhered to the fondant 102, the combination is left to cool, and the silicone mat 106 is preferably left in place during the cooling process. After the transfer is cool, the silicone mat and the removable plastic or acetate sheet attached to the transfer may be removed, and then the silicone mat is replaced directly over the transfer, which allows the transfer to firmly set up and prevents it from smearing. When the transfer is cool to the touch, the silicon mat may be removed, and the transfer/fondant combination may be applied to a cake or other confection in the traditional manner. Other confections may include cupcakes, pastries, or any other food item that may be enhanced with a frosting or icing layer on an outer surface thereof. An example of the final product is illustrated in FIG. 2.

A kit used for applying the transfers to the rolled fondant may include a silicone mat or other heat transfer mat, parchment paper, a heat source such as a craft iron, and optionally at least one chocolate transfer sheet and rolled fondant. Such a kit also includes instructions for usage.

It should be understood that the silicone mat, the parchment paper and the craft iron are merely examples of items that may be used for the steps of the process described herein. Any suitable heat transfer sheet or mat may be used in place of the silicone mat, and any suitable smooth surface sheet that will not burn or melt under a heat source may be used in place of the parchment paper. Further, although the heat source has been described herein as an iron, and as a craft iron in a preferred embodiment, it is contemplated that any suitable heat source may be used, so long as it has a generally flat heated surface that may glide over the heat transfer mat or the parchment paper without causing harm from excessive heat.

Although the present invention has been described in considerable detail with reference to certain preferred versions thereof, other versions are possible. Therefore, the spirit and scope of the appended claims should not be limited to the description of the preferred versions contained herein. All features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A process for applying transfers directly to fondant for decorating confections, said process comprising the steps of:
providing a fondant;
flattening said fondant to provide a substantially uniform thickness thereacross;
providing a transfer sheet having a transfer attached to a removable sheet;
positioning said transfer sheet on top of said flattened fondant so that the transfer side of said transfer sheet is in direct contact with said fondant and said removable sheet is positioned on an upper side of said transfer;
placing a heat transfer mat above said removable sheet;
providing a heat source having a substantially flat surface;
applying said flat surface of said heat source to said heat transfer mat in a substantially continuous motion to distribute heat across said heat transfer mat until said transfer is affixed to said flattened fondant; and
allowing said chocolate transfer sheet and said fondant to cool.

2. The process set forth in claim 1, further including the step of applying said fondant and said chocolate transfer to an outer surface of a confection.

3. The process set forth in claim 1, wherein said heat source is an iron.

4. The process set forth in claim 3, wherein said iron is a craft iron having a substantially flat continuous surface.

5. The process set forth in claim 1, wherein said heat transfer mat is a silicone mat.

6. The process set forth in claim 5, wherein said silicone mat is substantially transparent.

7. The process set forth in claim 2, wherein said confection is a cake.

8. The process set forth in claim 1, further including the step of removing said removable sheet from said transfer.

9. A food product comprising:
a confection having fondant applied to at least one outer surface thereof, and further including a decorative transfer applied directly to said fondant.

10. A food product as set forth in claim 9, wherein said confection is a cake.

11. A food product as set forth in claim 9, wherein said fondant is a rolled fondant.

12. A kit for applying transfers directly to fondant for decorating confections as defined in any of claims 1-8.
